(19) United States
(12) Patent Application Publication
(10) Pub. No.: US 2011/0110015 A1
(43) Pub. Date: May 12, 2011

(54) Methods to improve the efficiency and reduce the energy losses in high energy density capacitor films and articles comprising the same

(75) Inventors: Qiming Zhang, State College, PA (US); Qin Chen, State College, PA (US); Xin Zhou, State College, PA (US); Minren Lin, State College, PA (US); Shihai Zhang, State College, PA (US)

(73) Assignee: The Penn State Research Foundation, University Park, PA (US)

(21) Appl. No.: 12/082,595

(22) Filed: Apr. 11, 2008

Related U.S. Application Data
(60) Provisional application No. 60/907,628, filed on Apr. 11, 2007.
(60) Provisional application No. 61/023,602, filed on Jan. 25, 2008.

(51) Int. Cl. H01G 4/06

(52) U.S. Cl. 361/311; 29/25.42

(57) ABSTRACT

A multilayer film useful for capacitive applications comprises a high energy density layer and a dielectric blocking layer. In some embodiments, a conducting film is located between the high energy density layer and the blocking layer. The high energy density layer may be a fluoropolymer, such as a polymer or copolymer of poly-1,1-difluoroethene or a derivative thereof. The multilayer film may have high energy density (for example,. >8 J/cm³) and low dielectric loss, for example less than 2%, and preferably less than 1%.

### REFERENCE TO RELATED APPLICATIONS

This application claims priority from U.S. Provisional Patent Application Ser. Nos. 60/907,628, filed Apr. 11, 2007, and 61/023,602, filed Jan. 25, 2008, the entire content of both of which is incorporated herein by reference.

### STATEMENT REGARDING FEDERALLY SPONSORED RESEARCH OR DEVELOPMENT

This invention was made with Government support under Grant Nos. N00014-05-1-0455 and N00014-05-1-0541 awarded by the Office of Naval Research (ONR), and under Contract No. FA8650-07-M-2791 awarded by the by the US Air Force. The U.S. Government has certain rights in the invention.

### FIELD OF THE INVENTION

The present invention relates to dielectric materials and their applications, such as capacitors.

### BACKGROUND OF THE INVENTION

The commercial and consumer requirements for compact and more reliable electric power and electronic systems have grown substantially over the past decade. As a result, development of high electric energy and power density capacitor technology has grown to become a major enabling technology. Capacitors with high energy density, fast discharge speed, low ESR (equivalent series resistance), and graceful failure operation mode are required for many power electronics and electric power systems. Since capacitors occupy >50% of the overall volume in many conventional power converters and pulse power systems, capacitor performance, size, and reliability must be dramatically improved to meet the requirements of current and future power electronics and electric power systems.

It is desirable to have a capacitor with a combination of electrical properties, such as a high electric energy density, low dielectric loss and/or a fast discharge.

Conventional dielectric polymers such as biaxially oriented polypropylene (BOPP), polyethylene terephthalate (PET), and polycarbonate (PC) have been used widely for high energy density capacitors. However, their very low dielectric constant (less than 3.5) significantly limits the energy density available in the capacitors (˜1 J/cm³) made from these polymer films. Capacitors are described by Sarjeant et al., “Capacitive Components for Power Electronics”, Proc. IEEE, 89(6), pp. 846-855, (2001).

Recently, a class of polar fluoropolymers have been developed which show discharged energy densities >25 J/cm³ with fast discharge times (e.g. ˜1 ms). Polar fluoropolymers are described by B. Chu, and Q. M. Zhang in “A Dielectric Polymer with High Electric Energy Density and Fast Discharge Speed”, Science, Vol 313, page 334 (2006), and in “High Electric Energy Density Polymer Capacitors with Fast Discharge Speed and High Efficiency Based on Unique Poly(vinylidene fluoride) Copolymers and Terpolymers as Dielectric Materials”, WO 2007/078916, PCT/US2006/048258.

### SUMMARY OF THE INVENTION

Examples of the present invention include multilayer films, in particular multilayer dielectric films. Example films include a high energy density material and a dielectric material, in some cases further comprising a conducting film located between high energy density material and a dielectric material. Examples of the present invention include capacitors having a multilayer dielectric film according to an example of the present invention.

In some examples, a multilayer film comprises a bilayer film with a first layer and a second layer, the first layer being a blocking layer, and the second layer being a high energy density layer. In other examples, a multilayer film may have one or more blocking layers and one or more high energy density layers, preferably arranged in an alternating configuration.

A high energy density layer may comprise a polymer having a discharged electric energy density higher than 10 J/cm³ and, optionally, a discharge time faster than 10 millisecond, preferably faster than 1 millisecond. In some examples, the high energy density layer may comprise a high energy density material that can provide an electric energy density greater than about 10 J/cm³, more preferably greater than about 15 J/cm³, and in some examples approximately 25 J/cm³ or greater. For example P(VDF-CTFE) can provide an energy density of approximately 25 J/cm³. Energy density may be determined as the discharged energy density of a single layer of the high energy density material between a pair of electrodes. The high energy density layer may comprise a polar polymer, for example a polar fluoropolymer. An example polymer is poly(vinylidene difluoride), PVDF, also known as poly(1,1-difluoroethene), and other examples include other polymers, copolymers, and terpolymers of fluorinated monomers. The high energy density layer may comprise a polymer formed using vinylidene difluoride (VDF) or a VDF-derivative, including copolymers and terpolymers of VDF or derivatives thereof. Such materials may be referred to as PVDF-based (or VDF-based) polymers, and include polymers, copolymers, and terpolymers of VDF and derivatives thereof.

The blocking layer may be dielectric layer comprising a dielectric material having an electric resistivity higher than 10¹⁵ Ω·cm, and preferably higher than 10¹⁶ Ω·cm, and a dielectric loss less than 5%, and preferably less than 1%, and more preferably less than 0.2%.

Multilayer films can be produced by spin coating, solution cast, melt extrusion, vapor deposition, or processes combining two or more methods such as those above.

The high energy density layer may be a ferroelectric polymer, such as a ferroelectric fluoropolymer. The high energy density layer may comprise a high energy density material such as a polar polymer, in particular a polar fluoropolymer, or a blend of polar fluoropolymers. Example polar fluoropolymers include polymers such as PVDF, P(VDF-CTFE), P(VDF-CDFE), P(VDF-CFE), P(VDF-HFP), P(VDF-CDFE), P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), and P(VDF-TFE-CDFE), where VDF: vinylidenedifluoroethylene, HFP: hexafluoropropylene, VDF: vinylidenedifluoroethylene, CTFE: chlorotrifluoroethylene, CFE: chlorofluoroethylene, CDFE: chlorodifluoroethylene, TrFE: trifluoroethylene, and TFE: tetrafluoroethylene.

Other high energy density polymers include polar celluloses, polar siloxane polymers, acrylate polymers, polymers described in WO2007/078916, and other polymers, blends, or composites. The high energy density layer preferably comprises a material having a dielectric constant higher than 2, and preferably greater than 3, more preferably greater than 5, such as greater than 7, and a discharged energy density higher than 10 J/cm³, for example as measured using the breakdown field, or in some examples at 450 V/m.

The blocking layer may comprise an inorganic dielectric such as an inorganic nitride such as silicon nitride (Si₃N₄), aluminum nitride (AlN), an inorganic oxide such as hafnium oxide (HfO₂), a carbon-containing layer such as diamond-like-carbon; or a polymer dielectric such as polycarbonate (PC), poly(2,6-dimethy-1,4-phenylene oxide) (PPO), polystyrene (PS); or any materials, blends, or composite having desired properties. Preferably, the blocking layer comprises a dielectric material which has a dielectric loss less than about 1%, more particularly less than about 0.2%, and a volume electric resistivity greater than about 10¹⁵ Ω·cm, and preferably higher than 10¹⁶ Ω·cm.

A multilayer polymer film may have a high electric energy density (for example, greater than about 8 J/cm³), a low dielectric loss (for example, less than about 5%) and preferably below about 1% (i.e., less than 0.01 in the dielectric loss). Examples include polymer multilayer films having a discharge time of less than about 1 ms, and a dielectric loss of less than about 5% (for example, less than about 1%).

An example multilayer film may comprise two or more layers, for example comprising one or more blocking layers and one or more high energy density layers. The blocking layer(s) and high energy density layer(s) may alternate, though this is not necessary. A multilayer film may comprise blocking layers having different compositions, and/or comprise high energy density layers with different compositions.

Denoting blocking layers as Aₙ (or A-layers) and high energy density layers as Bₙ (or B-layers), a multilayer film may have the structure A₁B₁ (for example, a bilayer film or multilayer film including this configuration), A₁B₁A₂ or B₁A₁A₂ (for example, as a trilayer film or multilayer film including this configuration), and the like. For example, a multilayer film can have layer arrangements such as A₁B₁A₂B₂ A₃B₃A₄B₄ . . . , or A₁A₂B₁B₂A₃B₃ . . . , where A₁, A₂, . . . Aₙ represent different or similar compositions of blocking layers, and B₁, B₂, . . . Bₙ represent similar or different compositions. Example multilayers comprise at least one blocking layer and at least one high energy density layer.

The blocking layer may have a dielectric constant is greater than 2, preferably higher than 3, and more preferably higher than 7, and dielectric loss less than about 5%, and preferably less than about 1% (for example, measured at 1 kHz). In some example, the thickness ratio between a single A-layer and a single B-layer is in the range of 1/99 to 99/1. In some examples, the thickness ratio between a single A-layer (blocking layer) and a single B-layer (high energy density layer) is in the range of 5/95 to 95/5, preferably in the range 5/95 to 60/40. In some examples, the thickness ratio between a single A-layer and a single B-layer is in the range of 20/80 to 60/40. In some example, the thickness ratio between a single A-layer and a single B-layer is in the range of 30/70 to 60/40. The layer thickness for each layer can be in the range of from about 1 nm to about 10 microns, in particular from about 10 nm to about 5 microns, more particularly from 100 nm to 5 microns, such as from about 1 micron to 5 microns, and in some examples from about 10 nm to several hundred nanometers, for example to about 500 nm (all ranges herein are inclusive). The multilayer film may have a dielectric loss less 3%, such as less than 2%, and preferably less than 1%, and more preferably less than 0.2%.

Multilayer films can be fabricated using various methods, including, but not limited to, layer-by-layer spin casting, layer-by-layer plasma polymerization, layer-by-layer vapor deposition polymerization, multilayer coextrusion, and as self-assembled block copolymers.

The dielectric loss of the multilayer can be reduced by increasing the volume fraction of the blocking layer, for dielectric blocking layer materials having a lower loss than the high energy density layer. However, the dielectric constant and the energy density of the multilayer may be reduced at the same time. Therefore, the dielectric loss and the dielectric constant may be balanced considerations in selecting the thickness ratio of the layers.

The high energy density layer may comprise a cross-linked high energy density polymer such as a cross-linked fluoropolymer ferroelectric, or other polar polymer, including cross-linked polar polymers. Further, the blocking layer may comprise a cross-linked polymer.

In some embodiments, the discharged electric energy density of the multilayer film may be higher than 8 J/cm³, in some examples the discharge time of a capacitor formed from such as multilayer film is less than 10 ms (0.01 s), and preferably less than 1 ms (0.001 s), and in some examples the efficiency of a capacitor including a multilayer film is higher than 80%, and preferably higher than 85%.

In further example, a multilayer film may comprise a thin conductive layer located between a high energy density layer and a blocking layer, which may improve the reliability of the multilayer films. The thin conductive layer may have various electric patterns, and may be a thin sheet. A thin conductive layer may comprise a metal, such as Al, Ag, Au, Cu, Pt, Ni, or a conductive polymer. The thickness of the conductive layer can be in the range from 1 nm to 100 nm, such as between 1 nm and 10 nm, for example approximately 5 nm.

Examples of the present invention allow reduction or elimination of the conduction loss and ferroelectric hysteresis loss, and thereby improve the energy efficiency of this class of polar fluoropolymers, and similar approaches may use any high energy density polymer (for example, polymers having an energy density >10 J/cm³).

In another aspect of the present disclosure, the multi-layer dielectric system has a high operating temperature, e.g., greater than about 145° C. Such systems can be formed, for example, by combining one or more polar-fluoropolymer with one or more dielectric polymers or inorganic dielectrics where one or more of the dielectric layers have a high temperature stability.

Further, approaches described herein can be used with other polymers (including polymer blends, and polymer composites), in particular polymers which possess a dielectric constant higher than 7 or an energy density higher than 10 J/cm³, in reducing the conduction loss (less than 10%) and hysteresis loss (less than 10%) as well as improving the breakdown strength (higher than 500 MV/m).

### BRIEF DESCRIPTION OF THE DRAWINGS

FIG. 1A shows the discharged energy density directly measured from a polar-fluoro-copolymer as a function of field in capacitor;

FIG. 1B shows the dielectric properties as a function of frequency for P(VDF-CTFE) film; the data being acquired at room temperature from a stretched P(VDF-CTFE) copolymer film;

FIG. 1C shows a schematic of discharged energy density (shaded area) from a non-linear capacitor;

FIGS. 2A-2E show multilayer films according to embodiments of the present invention;

FIG. 3 shows a comparison of the polarization hysteresis loops of a P(VDF-TrFE) copolymer, which is a normal ferroelectric and exhibits a large ferroelectric hysteresis (loss), and a P(VDF-TrFE-CFE) terpolymer, which exhibits very little ferroelectric hysteresis loss;

FIG. 4 shows the charge-discharge curves with different applied field amplitude for the P(VDF-CTFE) 91/9 mol % uniaxially stretched films;

FIG. 5 shows the efficiency of a P(VDF-CTFE) 91/9 mol % film capacitor versus the applied electric field amplitude, where the upper curve is that after subtraction of the conduction loss of the data in FIG. 4;

FIGS. 6A-6B shows -the calculated dielectric constant and loss tangent of bilayer film using series capacitor model, where the bilayers comprise a PVDF-CTFE layer and one blocking layer, and PVDF-CTFE is assumed to have K=12 and D=0.03, the blocking layers have D=0.001, and K=2.8 (PPO), 7 (Si₃N₄), and 11 (Al₂O₃);

FIGS. 6C-6F show dielectric properties of multilayer films;

FIG. 7 shows the equivalent circuit of the bilayer structure, where 1: blocking layer and 2: PVDF-CTFE;

FIG. 8 shows the reduction of the conduction loss from the circuit model of FIG. 7 for different blocking layer (K=7) thickness (to the dielectric film, K=12): 0 (no-blocking layer), ½, and 1;

FIGS. 9A-9C show the charge-discharge curves measured at 100 Hz for PPO/P(VDF-CTFE) bilayer films with different thickness ratio: (A) ¼; (B) ½; (C) 1/0;

FIG. 10 shows the electric field in the blocking layer when the nominal applied field for the bilayer is 300 MV/m;

FIGS. 11A-11B show the charge-discharge curves for (11A) pure Si₃N₄ film and (11B) a Si₃N₄/P(VDF-CTFE) ½ thickness ratio film, where the frequency is 100 Hz;

FIG. 12A is an illustration of a bilayer dielectric film with a thin conductive layer between a high energy density layer and a blocking layer, shown as the thick black line), where the conductive layer thickness can be very thin, for example, ˜5 nm;

FIG. 12B shows a conductive layer at interfaces of high energy density layers and blocking layers;

FIG. 13 shows the effect of crosslinking (due to irradiation) on reducing the ferroelectric hysteresis loss in 6× uniaxially stretched P(VDF-CTFE) 91/9 mol % films;

FIG. 14 shows charging the multilayer capacitor film at 1 microamp constant current to 800 V;

FIG. 15 is a chemical structure of a thermally stable cross-linking agent;

FIG. 16 shows celluloses with high dielectric constant above 5, where R is CN—, CNCH₂—, CNCH₂CH₂—, CF₃—, CF₃CH₂—, or CF₃CH₂CH₂—, and R′ is —CH₂CH₃ or —H;

FIG. 17 shows siloxane polymers with high dielectric constant above 5, where X can be selected from CN—, CNCH₂—, CNCH₂CH₂—, CF₃—, CF₃CH₂—, or CF₃CH₂CH₂—, and y/z varies from 90/10 to 0/100;

FIG. 18 shows acrylate polymers with high dielectric constant (above 5), where X can be selected from CN—, CNCH₂—, CNCH₂CH₂—, CF₃—, CF₃CH₂—, or CF₃CH₂CH₂—. Y₁, Y₂ and Y₃ can be selected from H—, CH₃—, CH₃CH₂—, and the like, and m/n varies from 90/10 to 0/10; and

FIGS. 19A-19C shows the dielectric constant and loss of the polar fluoropolymer blends of P(VDF-CTFE) and P(VDF-TrFE-CFE), and the blends can be used in a high energy density dielectric layer.

### DETAILED DESCRIPTION OF THE INVENTION

Recently, we discovered and developed a class of polar fluoropolymers which show discharged energy densities >10 J/cm³, in some examples >15 J/cm³, and in some examples >25 J/cm³, with fast discharge times, such as approximately 1 millisecond. This class of fluoropolymers also exhibits a reasonable dielectric loss (e.g. less than 5% @ 1 kHz).

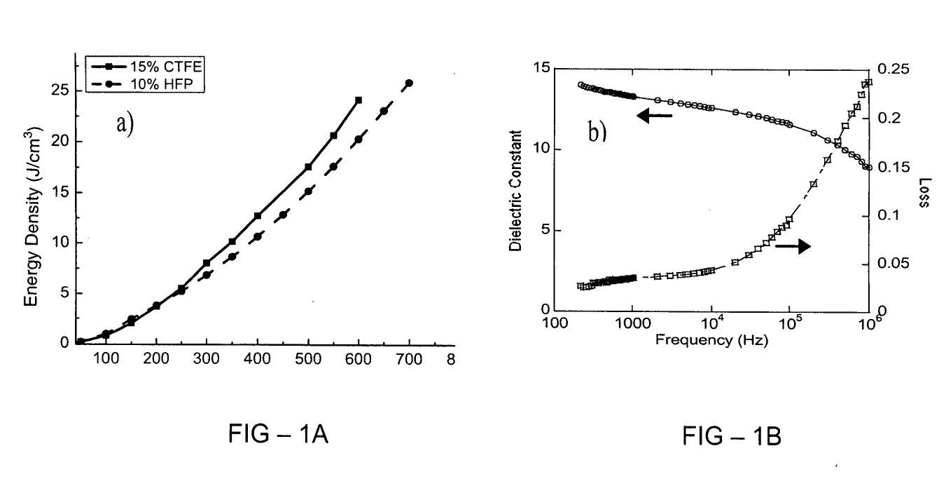

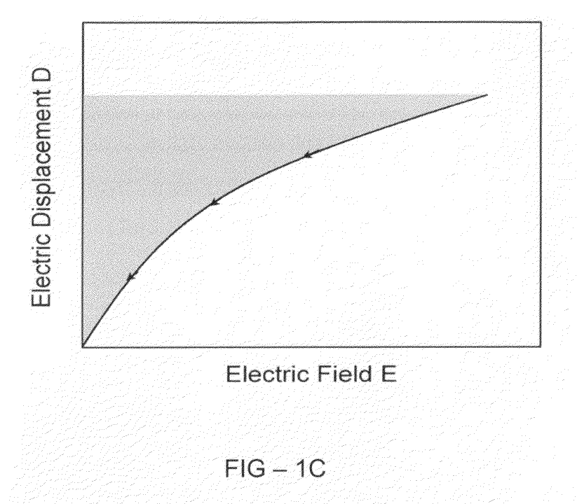

FIG. 1A shows the discharged energy density directly measured from a polar-fluoro-copolymer as a function of field in a capacitor. FIG. 1B shows the dielectric properties as a function of frequency for a P(VDF-CTFE) film, which is ˜3% (0.03) at 1 kHz to 10 kHz frequency range. The data were acquired at room temperature from stretched P(VDF-CTFE) and P(VDF-HFP) copolymer films.

However, these high energy density polar fluoropolymers exhibit increased energy loss at high electric field, as discussed in further detail below. Embodiments of the present invention include approaches to improve the efficiency and reduce the energy losses while still maintaining a high energy density. Examples of the present invention include multilayer structures, including a high energy density layer and a blocking layer. For example, a multilayer structure may include alternating layers of a high energy density polymer, such as a polar fluoropolymer, and a blocking layer having high volume resistivity (for example, a volume resistivity greater than the polar fluoropolymer). The term blocking layer may be used to describe layers introduced to reduce losses, possibly including conducting losses and/or hysteresis losses.

Representative high energy density polymers are described in Int. Pat. Pub. No. WO2007/078916 (PCT/US2006/048258) to Zhang et al., the contents of which are incorporated herein by reference. High energy density polymers include VDF-based polymers. The term VDF-based polymer includes polymers (including copolymers and terpolymers) of VDF and/or derivatives of VDF.

In general, the energy density of a dielectric material can be derived from Uₑ=∫EdD, which is the shaded area in FIG. 1C. Here E is electric field and D is electric displacement. For linear dielectric materials with a dielectric constant K,

Uₑ=½ DE=½ Kε₀E² (1)

where ε₀ is the vacuum permittivity (=8.85×10⁻¹² F/m). For a capacitor operated at high field, the presence of various losses, such as the leakage current loss (conduction loss) and dielectric loss, will cause the charge curve (the voltage applied to a capacitor increases) deviates from the discharge curve (when the voltage in a capacitor is reduced). For polar fluoropolymers which belong to a class of ferroelectric materials, there is a possibility of ferroelectric hysteresis loss.

Examples of the present invention include preparing multilayered films (including nano-structured multilayer polymer films) having at least one high energy density layer and at least one blocking layer. Denoting the blocking layers as A-layers and the high energy density layers as B-layers, the multilayer film may have a structure such as AB, ABA, BAB, ABAB, ABABA, BABAB, ABABAB . . . , and the like.

Examples of the present invention include multilayer dielectric film with alternating high energy density layers (e.g. polar fluoropolymer) and blocking layers (e.g. low loss dielectric layers). The outer layers of the multilayer structure that are in direct contact with the electrode can be either the high energy density polar fluoropolymer layer or the low loss dielectric layer.

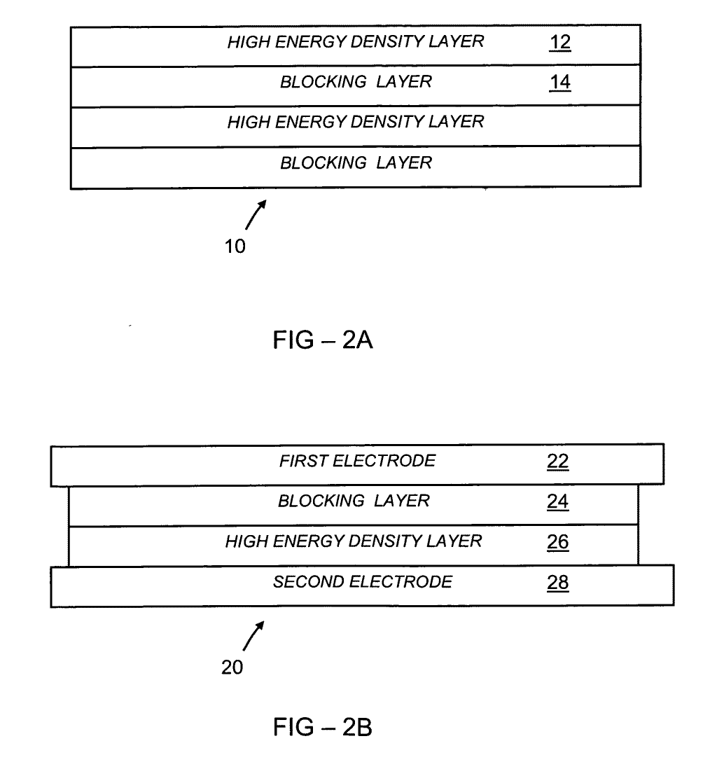

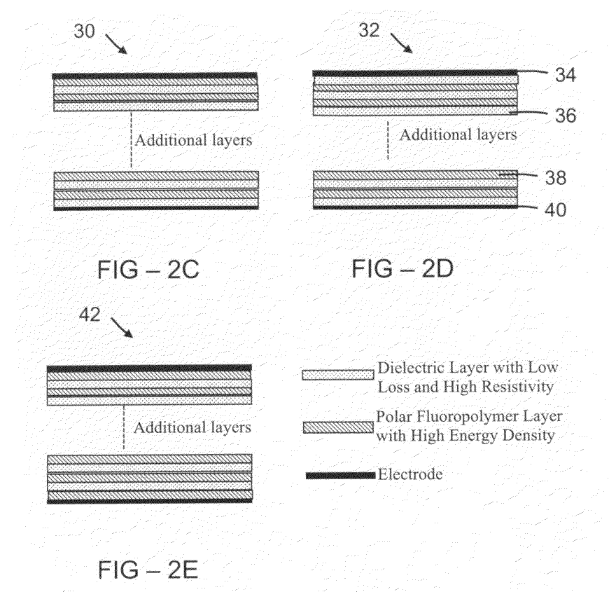

FIG. 2A shows a schematic of a 4-layer BABA multilayer film 10. In representative examples, the A-layers 14 may comprise a low dielectric loss material (alternatively, or in addition, a high resistivity material). The B-layers 12 may comprise a high energy density material, such as a polar polymer, in particular a polar fluoropolymer. For example, a B-layer may comprise a polymer selected from polar fluoropolymers including (but not limited to) PVDF, P(VDF-HFP), P(VDF-CFE), P(VDF-CTFE), other copolymers of VDF and derivatives thereof, P(VDF-TFE-CTFE), P(VDF-TrFE-CFE), and P(VDF-TrFE-HFP). The A-layers may be selected from low dielectric loss polymer, for example polymers having a dielectric loss less than 1%, such as polymers listed in Table 1 below and accompanying text. The A-layers may comprise a high resistivity material, such as an inorganic dielectric, or other polymers or material with similar dielectric properties.

FIG. 2B shows a schematic of an apparatus 20 comprising a first electrode 22, blocking layer (A-layer) 24, high energy density layer (B-layer) 26, and second electrode 28. In this example, the multilayer film is an AB bilayer structure. The apparatus may be (or may be a component of) a charge storage device (such as a capacitor), actuator, sensor, battery, electric motor, defibrillator, and the like.

FIGS. 2C-2E show further schematic drawings of multilayer capacitor film, structures, shown at 30, 32, and 42. The electrode layer can be in contact with either the polar fluoropolymer layer or the dielectric layer with low loss and high volume resistivity. FIG. 2D shows a multilayer film apparatus 32 comprising first electrode 34, blocking layer (e.g. comprising a dielectric having low dielectric loss and/or high resistivity), high energy density layer (e.g. comprising a polar fluoropolymer) 36, and second electrode 38. The structures 30 and 42 have similar structures, and these figures illustrate that either high energy density layers, blocking layers, or one of each, may be adjacent the electrodes.

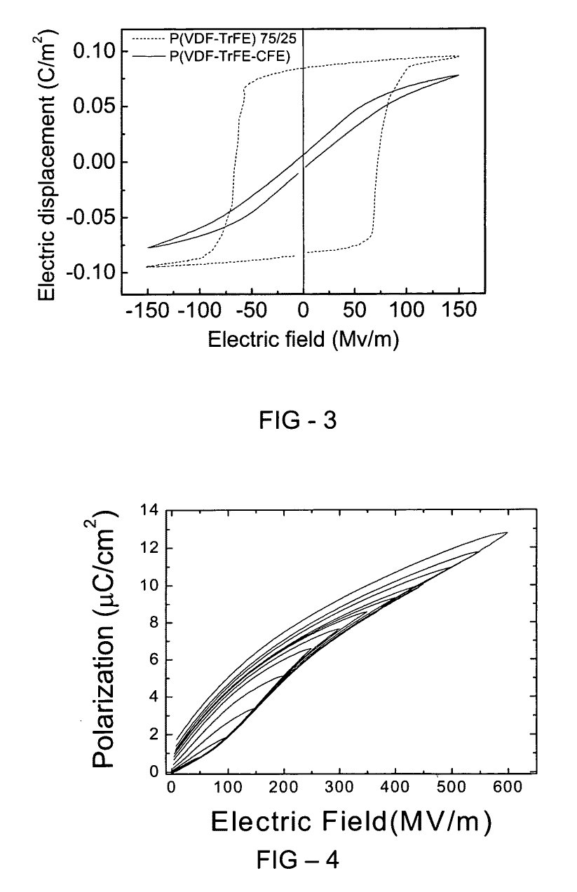

FIG. 3 shows a comparison of the polarization hysteresis loops of a P(VDF-TrFE) copolymer, poly(vinylidene fluoride-trifluoroethylene), which is a normal ferroelectric and exhibits a large ferroelectric hysteresis (loss), and a relaxor ferroelectric terpolymer of P(VDF-TrFE-CFE) (CFE: chlorofluoroethylene), which exhibits very little ferroelectric hysteresis loss. For the normal ferroelectric P(VDF-TrFE), a very large polarization hysteresis exists, while for the P(VDF-TrFE-CFE) terpolymer, the hysteresis loss is greatly reduced or nearly eliminated. Hence, embodiments of the present invention allow hysteresis loss to be substantially reduced, while retaining a high energy density. For example, multilayer films may be prepared having an energy density greater than 8 J/cm³.

The high energy density polar fluoropolymer capacitor films have very fast discharge speed. The stored energy in the film capacitor can be discharged to a load resistor faster than 1 ms.

In some examples of the present invention, a multilayer film comprises at least one layer of a normal ferroelectric (such as P(VDF-TrFE)), and at least one layer of a relaxor ferroelectric (such as a fluoropolymer terpolymer) having a hysteresis loss substantially less than the normal ferroelectric layer.

FIG. 4 shows the charge-discharge cycles of a P(VDF-CTFE) 91/9 mol % (85/15 by weight) copolymer (CTFE: chlorotrifluoroethylene) film capacitor. There are many charge-discharge curves shown in FIG. 4, each corresponding to a charge-discharge curve obtained under a maximum applied field. The highest applied field for the data in FIG. 4 is 600 MV/m. For each charging-discharging curve, there is one half-cycle in which the electric field is increased to a maximum value (charging cycle, corresponding to the lower branch of the curve) and a half-cycle of discharge curve (reducing the field, the upper branch of the curve). The area enclosed by the charge and discharge curves correspond to the loss, which for the copolymer includes the ferroelectric hysteresis loss, the conduction loss, as well as dielectric loss.

P(VDF-CTFE) is used as an exemplary high energy density material, but the invention is not limited by these examples.

To better characterize all these losses in a capacitor during a charge-discharge cycle, we define an efficiency parameter which is defined as:

Efficiency=Discharged energy density/Total input energy density during charge (2)

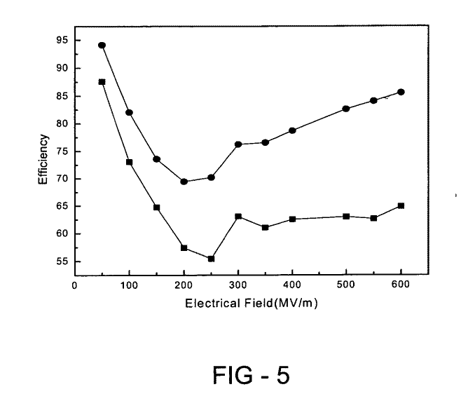

FIG. 5 shows the efficiency thus obtained for the charge-discharge curves versus the maximum applied field for each curve (the square curve or the lower curve). The large drop of the efficiency of the capacitor with applied field amplitude below 250 MV/m is due to the ferroelectric hysteresis loss as well as the conduction loss.

Examples of the present invention allow reduction or elimination of the conduction loss and/or ferroelectric hysteresis loss, and thereby improve the efficiency of this class of polar fluoropolymers. Examples of the present invention include multilayer films comprising any high energy density polymers (for example, any polymer having an energy density >10 J/cm³), and allow conduction loss and/or hysteresis losses to be substantially reduced compared to an unstructured film of the high energy density polymer.

The approaches of this invention can be applied to other polymers, polymer blends, and polymer composites, in particular to materials which possess an energy density higher than 10 J/cm³ , so as to reduce the conduction loss and/or hysteresis loss, as well as to improve the breakdown strength in some examples.

### Dielectric Blocking Layer in Bilayer or Multilayer Films

One main energy loss mechanism in the capacitor charge-discharge cycle in the polar fluoropolymers is conduction loss since these materials have a relatively low volume resistivity of ˜10¹⁴ Ω·cm at high fields (>50 MV/m). Therefore, the capacitor charge—discharge efficiency will be improved by approaches that can reduce the leakage current.

Embodiments of the present invention allow losses to be reduced through provision of multilayer films having at least one blocking layer. The blocking layer may be a dielectric layer selected to reduce leakage current losses (for example, comprising a material having an electrical resistivity one or more orders of magnitude greater than the high energy density material), and/or to reduce hysteresis loss.

Several dielectric materials, such as Si₃N₄, AlN, PS, PPO, PP, PET, PC, etc., possess very low leakage current and dielectric loss and can be used to reduce the conduction loss or leakage current in a multilayer structure comprising a high energy density layer, such as a layer comprising P(VDF-CTFE) or other similar high energy density dielectric polymers. Use of blocking layers comprising low leakage current and/or low loss materials allows losses to be reduced for e.g. film capacitor applications, increasing efficiency of operation, and lowering wasted energy and heat generation.

For example, by coating a layer of these dielectric materials with a layer of P(VDF-CTFE), or preferably forming a multilayer film with alternating layers of P(VDF-CTFE) and blocking layers comprising low-loss and low leakage current dielectric materials, the conduction loss and dielectric loss of the dielectric film can be reduced or totally eliminated while maintaining high energy density and graceful failure of the film.

Table I below lists several examples of the low loss low leakage current dielectric materials which may be used for this purpose. This table is for illustrative purpose and other dielectrics with low dielectric loss can also be used as coating layer or in multilayer films.

TABLE I
Dielectric properties of selected low loss low leakage dielectric materials
(T_{g}: glass transition, and Tₘ: melting transition for polymer dielectrics).

| | Dielectric | Dielectric | | | |
|---|---|---|---|---|---|
| | constant | loss | Resistivity | T_{g} (° C.) | Tₘ (° C.) |
| Polystyrene (PS) | 2.5 | 0.02% | | 120 | 280 |
| Polycarbonate (PC) | 3.1 | 0.2% | >10¹⁷ Ωcm | 149 | 267 |
| Polypropylene (PP) | 2.3 | 0.02% | >10¹⁷ Ωcm | | 160 |
| Poly(2,6-dimethy-1,4-phenylene oxide) (PPO) | 2.8 | 0.05% | >10¹⁶ Ωcm | 220 | |
| Polyethylene terephthalate (PET) | 3.3 | 0.2% | >10¹⁶ Ωcm | 78 | 245 |
| Polyethylene naphthalate (PEN) | 3.2 | 0.5% | >10¹⁶ Ωcm | 120 | 280 |
| Poly(ethylene-co-tetrafluoroethylene) (ETFE)) | 2.7 | 0.08% | >10¹⁷ Ωcm | | 265 |
| Polyetheretherketone (PEEK) | 3.3 | 0.35% | >10¹⁶ Ωcm | 157 | 374 |
| Poly(phenylene sulfide) (PPS) | 3.1 | 0.06% | >10¹⁷ Ωcm | 88 | 280 |
| Polyether imide (PEI) | 3.2 | 0.35% | >10¹⁶ Ωcm | 217 | |
| Polysulfone | 3.0 | 0.1% | >10¹⁶ Ωcm | 190 | |
| Si₃N₄ | 7-7.5 | <0.1% | >10¹⁶ Ωcm | | |
| AlN | 7-10.4 | <0.1% | | | |
| Diamond-like-carbon | >3.5 | | | | |
| P(MDA/MDI) (MDA: 4,4′- | 4-14 | 1% | | | >200 |
| diaminodiphenylmethane; MDI: 4,4′- | | | | | |
| diphenylmethane diisocyanate) | | | | | |

Other examples include polyoxymethylene (POM, loss 0.1%), polydimethylsilane (PDMS, loss 0.01%), polysulfone (e.g. Udel, loss 0.1%), polyimide (e.g. Apical, loss 0.14%; Kapton, loss 0.15%), Teflon AF (loss 0.02%), other non-polar fluoropolymers such as polymers of perfluoroalkyl and perfluoroalkoxy monomers, polyethylene (PE, loss 0.1%-1%), and parylene C (loss 0.02%).

The dielectric blocking layer (“blocking layer”) may comprise a low loss and low leakage current (high volume resistivity) dielectric material, and can be used to block the conduction current of a high energy density polymer. The dielectric constant of the blocking layer may be close to that of the high energy density polymer layer. A thickness ratio between a blocking layer and a high energy density layer can be chosen to achieve an improved effective blocking effect (reduce the leakage current and dielectric loss while maintaining high energy density). The thickness ratio can be determined using the desired dielectric loss improvement and the energy density needed. The blocking layer allows reduction of the conduction loss and dielectric loss, but reduces the energy density of the multilayer as the polar-fluoropolymer films have the highest energy density.

The blocking layer may be processed or synthesized at a temperature not too high to damage the high energy density dielectric polymer layer, (for example, P(VDF-CTFE) layer, which may be damaged if the coating layer fabrication temperature is above 160° C.

Suppose the two dielectric layers in the multilayer film are characterized by the complex dielectric constant:

ε₁=ε′₁−iε″₁

ε₂=ε′₂−iε″₂ (3)

where the real and imaginary parts are related by the loss tangent

$$tan {δ}_{1} = \frac{{ɛ}_{1}^{″}}{{ɛ}_{1}^{′}} , \\ tan {δ}_{2} = \frac{{ɛ}_{2}^{″}}{{ɛ}_{2}^{′}} \qquad ( 4 )$$

In general, the complex capacitance per unit area of a film can be expressed as C=ε/d, where d is the thickness. The response of the multilayer can be determined using the series capacitor formula:

$$\frac{1}{ɛ} = \frac{1}{{d}_{1} + {d}_{2}} ( \frac{{d}_{1}}{{ɛ}_{1}} + \frac{{d}_{2}}{{ɛ}_{2}} ) \qquad ( 5 )$$

Here, P(VDF-CTFE) and a blocking dielectric layer are used as an example, however other high energy density polymers may be used.

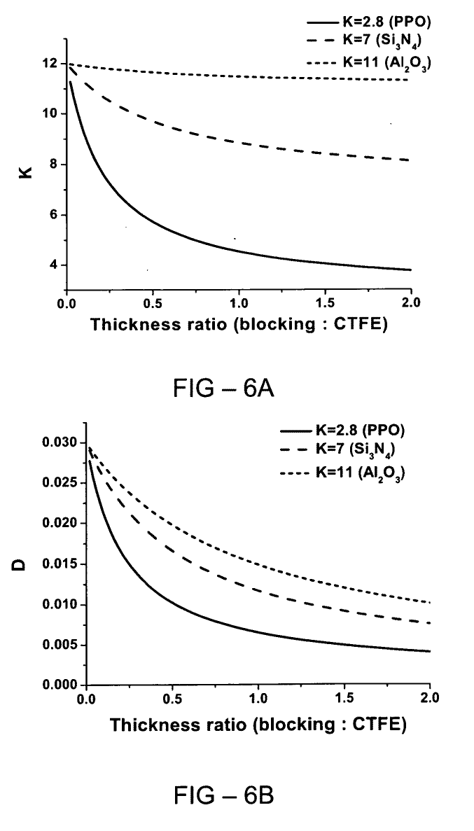

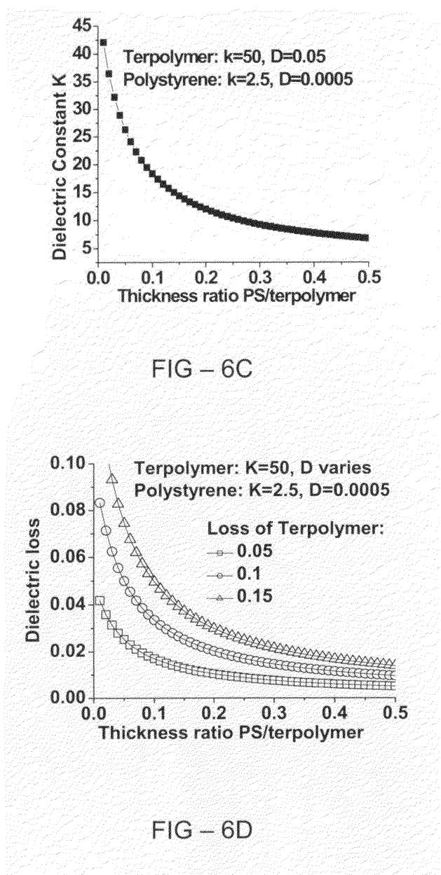

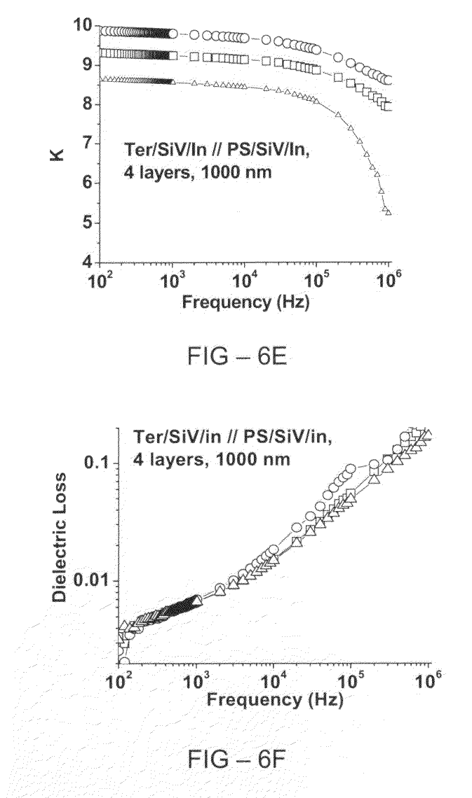

FIGS. 6A-6B shows the calculated dielectric constant and loss tangent using the series capacitor model of Equation (5) for bilayer films of P(VDF-CTFE) and a blocking layer as a function of the ratio of the blocking layer d₁ to the P(VDF-CTFE) layer d₂. The bilayers include one PVDF-CTFE layer and one blocking layer. PVDF-CTFE is assumed to have K=12 and D=0.03; the blocking layers have D=0.001 and K=2.8 (corresponding to the dielectric constant of PPO), 7 (Si₃N₄), and 11 (Al₂O₃). The results show that the loss of the films can be significantly reduced through use of the blocking layer.

FIGS. 6C-D show the calculated dielectric constant and loss tangent using the series capacitor model of Equation (5) for bilayer films of PVDF-TrFE-CFE with polystyrene (PS) blocking layer as a function of the thickness ratio of the PVDF-TrFE-CFE layer to the blocking layer polystyrene. The bilayer includes one PVDF-TrFE-CFE layer and one PS blocking layer. PVDF-TrFE-CFE is assumed to have K=50 and D varies with frequency; the blocking layer PS has D=0.0005 and K=2.5. The results show that the loss of the films can be reduced to below one.

Model calculation results are shown for a multilayer polymer film of polystyrene and PVDF-TrFE-CFE terpolymer as a function of the thickness ratio of two layers. The figures show dielectric constant (FIG. 6C) and dielectric loss (FIG. 6D) as a function of the thickness ratio of the two layers. The dielectric properties are deduced from a model calculation for a multilayer film with ABABAB sequence. The layer thickness for A is d₁ and for B is d₂, there is assumed to be no interface effect, and the dielectric permittivity K of the multilayer is given using Equation 5 above. In the model calculation, the dielectric constant of a P(VDF-TrFE-CFE) terpolymer (B-layer) is K=50 and that of the low loss polymer (A-layer) is K=2.5. The dielectric loss of the terpolymer is 5% (0.05), 10% (0.1), and 15% (0.150), (for different frequencies), and for the low loss polymer is 0.0005. The dielectric properties used for the A-layers are close to those of PPO and PS as listed in Table I.

As seen from FIGS. 6C and 6D, for such a multilayer polymer system, a dielectric constant K higher than 10 and a dielectric loss lower than 1% can be obtained. Because both polymers used possess very high dielectric strength, a high dielectric strength of the multilayer film is expected, which leads to high electric energy density in these multilayer polymers with low loss.

FIGS. 6E-6F shows the experimental dielectric data for a multilayer polymer film fabricated using a spin cast method. Dielectric properties are shown as a function of frequency for a PVDF-TrFE-CFE terpolymer/PS multilayer film of 1000 nm thickness (circles: measured at 1 KHz; squares: 10 KHz; triangles: 1 kHz.). In the multilayer film, one layer is a P(VDF-TrFE-CFE) 59.2/33.6/7.2 mol % random terpolymer, and the other dielectric blocking layer is polystyrene (PS). The thickness ratio between the two layers is 2/1. The multilayer film was prepared by layer-by-layer spin coating of P(VDF-TrFE-CFE) and PS. The solvents used can be acetone or methyl ethyl ketone (MEK) for the terpolymer, and toluene was used for the spin coating of PS. A crosslinking agent was added to the spin cast films so that the layers already formed were not dissolved by the solvent in the subsequent layer spin cast process. The crosslinking agent chosen for the multilayer films in this example was 1,5-divinylhexanmethyltrisiloxane (DVHMS) H₂C═CH—Si(CH₃)₂—O—Si(CH₃)₂—O—Si(CH₃)₂—CH═CH₂. The initiator for DVHMS was benzoyl peroxide (BPO), C₆H₅—C(O)—O—O—(O)C—C₆H₅.

As can be seen from Table I above, PDMS shows very low dielectric loss and the crosslinking agents based on dimethyl siloxane also show low dielectric loss which is highly desirable since these crosslinking agents will not increase the dielectric loss.

As can be seen, a dielectric constant higher than 9 and a dielectric loss (at 1 kHz) less than 1% (0.7%) were obtained for this multilayer film.

Table II lists some of the properties of the multilayer polymer system and the comparison with the P(VDF-TrFECFE) relaxor ferroelectric terpolymer. The table shows a comparison of the multilayer film (using PS or PPO, as indicated) and the terpolymer, showing dielectric constant (and dielectric loss in brackets) at three frequencies. The multilayer films were prepared by spin coating.

TABLE II

| | Dielectric constant (loss) at | | |
|---|---|---|---|
| | different frequencies | | |
| Terpolymer/PS or PPO | 1 kHz | 10 kHz | 100 kHz |
| Terpolymer/PS, 1000 nm 4 layers | 9.2 (0.005) | 9.1 (0.013) | 8.8 (0.056) |
| Terpolymer/PPO, 1200 nm | 9.0 (0.012) | 8.8 (0.021) | 8.4 (0.048) |
| Terpolymer P(VDF-TrFE-CFE) | 56 (0.073) | 49 (0.14) | 33 (0.4) |

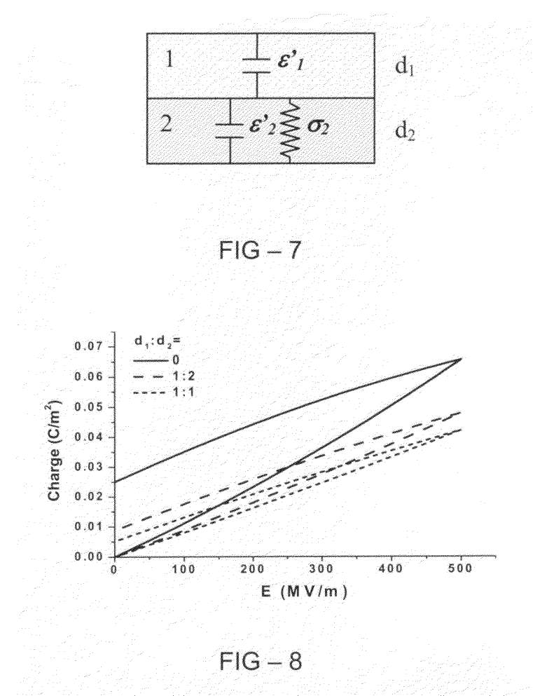

FIG. 7 shows conduction loss in P(VDF-CTFE). If conduction loss is present, as illustrated for P(VDF-CTFE), as the conductivity σ₂, it can similarly be shown that the conduction loss from σ₂ can be suppressed by the presence of a blocking layer.

FIG. 8 shows a simulation result for the charge-discharge curve of a higher dielectric loss dielectric layer having a dielectric constant of 12 to simulate the P(VDF-CTFE) layer, with and without the presence of a blocking layer. The conduction loss of the blocking layer is assumed to be zero and dielectric constant is 7, to simulate a Si₃N₄ layer. The thickness ratio between the blocking layer and lossy dielectric layer is also varied. The difference in the electric displacement at E=0 between the discharge and charge (D=0) curve is an indication of the degree of conduction. The blocking layer markedly reduces the conduction loss.

Using a P(VDF-CTFE) layer, the conduction loss is largely determined by the charge injection at the polymer-electrode interface, and a blocking layer can effectively block the charge injection and consequently significantly reduce the conduction loss.

Two dielectric materials were used as a blocking layer, PPO (K=2.8) and Si₃N₄ (K=7). In these examples, the high energy density layer was P(VDF-CTFE) 91/9 mol % dielectric layer. As will be seen, Si₃N₄, because its dielectric constant is closer to that of P(VDF-CTFE) (K=13), has better blocking effect than that of PPO. The deposition of Si₃N₄ on P(VDF-CTFE) films was carried out by plasma-enhanced chemical vapor deposition (PECVD) method at a chamber temperature 30° C. to 160° C. This temperature is suitable for P(VDF-CTFE) polymer films and no damage to the polymer films was observed.

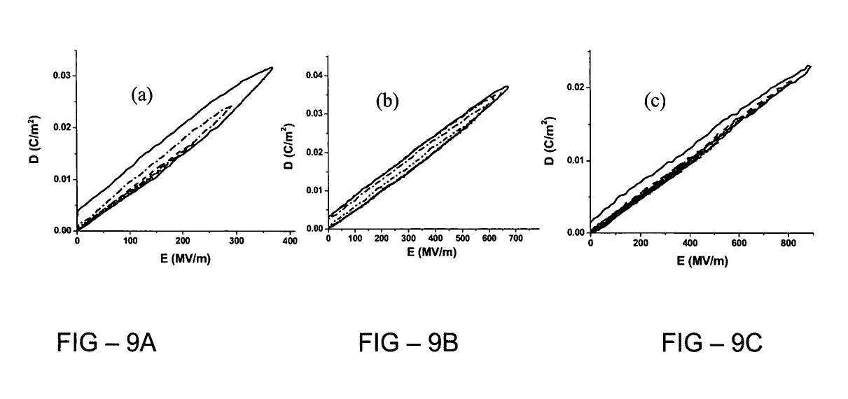

FIGS. 9A-9B presents the charge-discharge curve (measured at 0.01 s or 100 Hz) for PPO/P(VDF-CTFE) bilayer films with ¼ (FIG. 9A) and ½ (FIG. 9B) thickness ratio. For comparison, FIG. 9C shows the charge-discharge curve for PPO film only.

As can be seen, the ½ ratio film shows better reduction in the conduction loss and a higher efficiency. For example, under 665 MV/m, the discharged energy density is more than 11.5 J/cm³ with an efficiency=92%. Even though PPO has a very low loss and leakage current, at very high field, the tunneling current leads to higher loss at above 800 MV/m. Because of a large dielectric constant contrast between the PPO and P(VDF-CTFE) layer (2.8 vs 13), the real electric field in PPO is much higher than the average field, which can lead to increased tunneling current as well as electric breakdown of the PPO layer. As can be seen in FIG. 9B, the conduction loss is very low at below 500 MV/m. Above that field, this loss is increased.

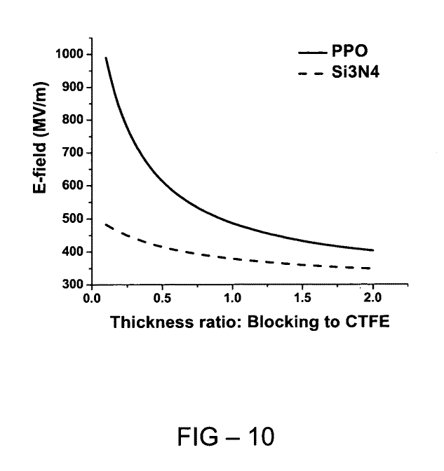

FIG. 10 illustrates the real field in the blocking layer versus the layer thickness ratio between the blocking layer and P(VDF-CTFE) (assuming to have a dielectric constant K=12 in the calculation. In the real films, the dielectric constant is >14 and increases with electric field amplitude). As can be seen for the PPO blocking layer, even though the average nominal field is 300 MV/m, for a ½ ratio film, the actual field in the PPO layer is more than 600 MV/m, doubling that of the applied field. In contrast, for K=7 (Si₃N₄ layer) at ½ thickness ratio, the actual field in Si₃N₄ film is just above 400 MV/m.

A higher dielectric constant blocking layer has an added advantage. It can significantly reduce the tunneling current since the tunneling current is proportional to ˜exp(−A (K)^{1/2}) where A is a constant related to the energy barrier and K is the dielectric constant.

These multilayer films can be fabricated using various methods, including, but not limited to, layer-by-layer spin casting, layer-by-layer plasma polymerization, multilayer coextrusion, as well as self-assembled block copolymers.

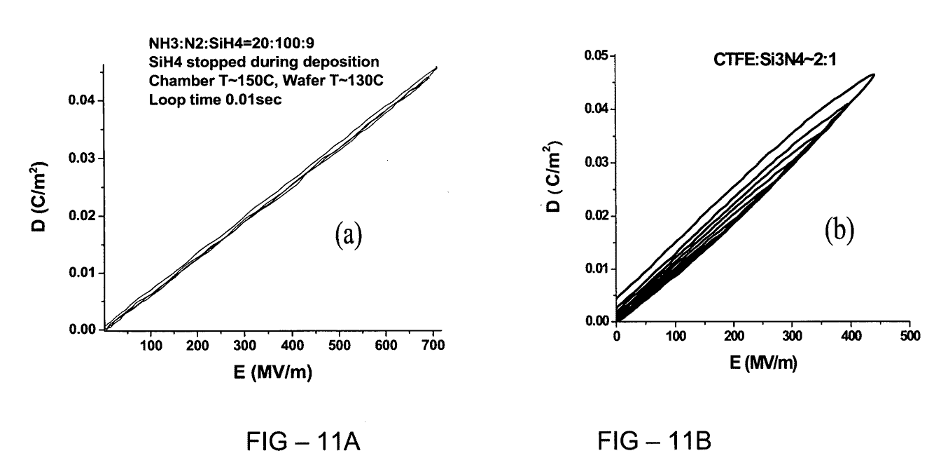

FIGS. 11A-11B present the charge-discharge curves for a Si₃N₄ film and a ½ (1 to 2) thickness ratio bilayer films of Si₃N₄/P(VDF-CTFE). The Si₃N₄ film shows very low loss due to low dielectric loss and very low trap density (very low current injection). Furthermore, it also shows a high energy density (>15 J/cm³) under 700 MV/m. However, the inorganic nature of the films, with possible catastrophic failure, may cause problems in high energy density capacitor applications. In addition, Si₃N₄ typically becomes brittle at thickness above 2 μm and it is difficult to make into free standing film for capacitor winding.

For the bilayer, the charge injection and conduction loss are reduced markedly. At 440 MV/m, the discharged energy density is 9.3 J/cm³ with an efficiency of 91%. Compared with FIG. 5, the results indicate that the use of a blocking layer can markedly cut down the charge injection and conduction losses. For example, FIG. 5 shows that efficiency can be increased at least 10% over the electric field range 50-600V.

In a bilayer (or other multilayer) films comprising alternating A and B dielectric layers (such as the ones illustrated here A=Si₃N₄ and B=P(VDF-CTFE)), the breakdown field can be further improved by inserting a conductive layer in between layer A and B. Such a thin conductive layer can dissipate the charge accumulated at the interface between the layers A and B if a local breakdown occurs in either layer A or layer B and thus markedly improve the reliability and breakdown strength of the film.

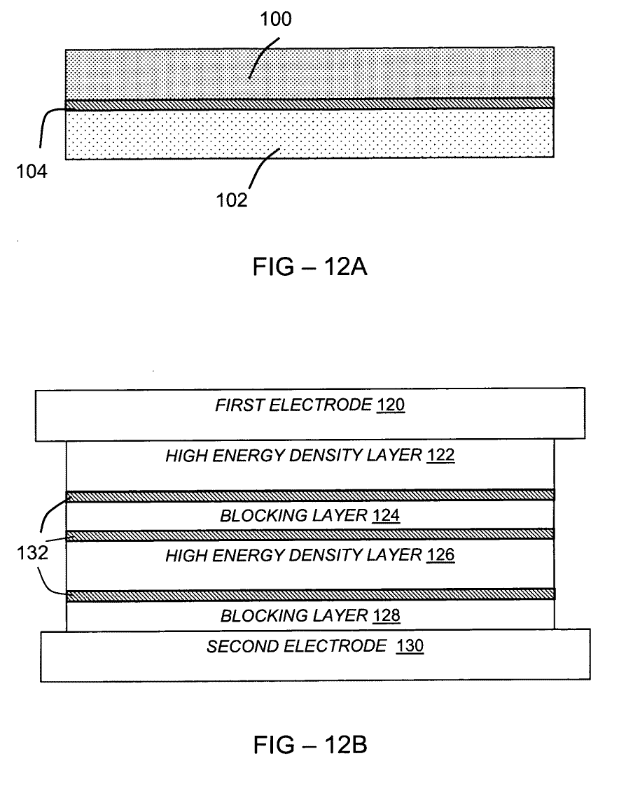

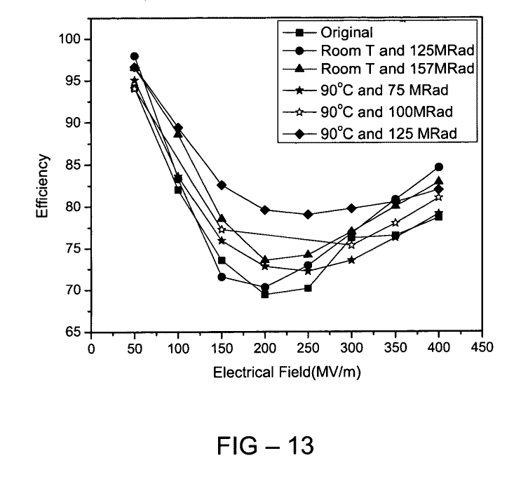

FIG. 12A schematically illustrates a bilayer dielectric film with a thin conductive layer 104 between first and second dielectric layers, 100 and 102. The conductive layer thickness can be very thin, for example, ˜5 nm. The first layer can be a high energy density layer, and the second layer can be a blocking layer.

FIG. 12B shows an apparatus comprising a first electrode 120, high energy density layers 122 and 126 in an alternating configuration with blocking layers 124 and 128, with second electrode 130. Conducting layers 132 are located between adjacent high energy density layers and blocking layers.

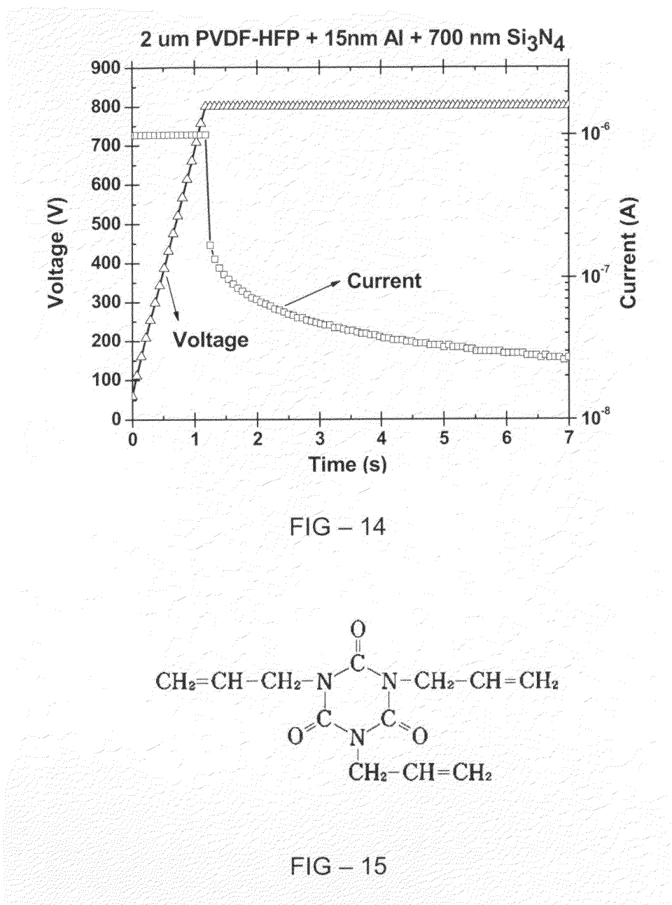

FIG. 13 shows the effect of crosslinking (due to irradiation) on reducing the ferroelectric hysteresis loss in 6× uniaxially stretched P(VDF-CTFE) 91/9 mol % films.

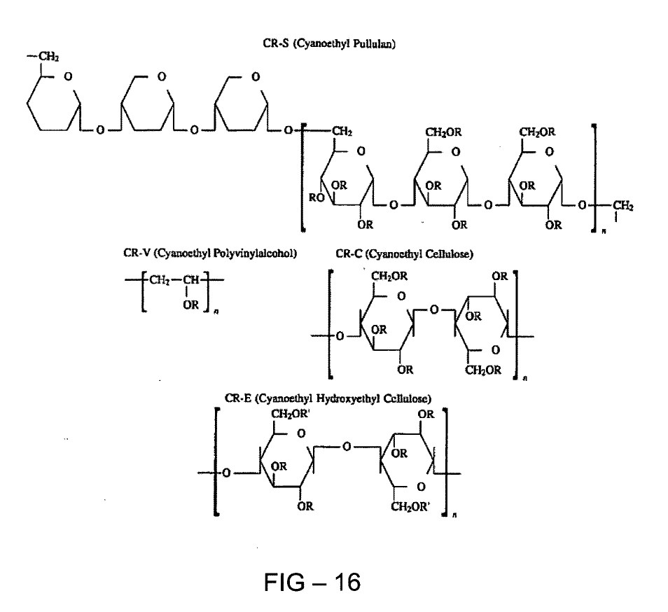

FIG. 14 presents the charging behavior of a fabricated three layer capacitor film, comprising a 6× stretched 2 μm PVDF-HFP film, a 15 nm thick Al layer on top of the P(VDF-HFP) base film, and then a 700 nm thick Si₃N₄ layer. The P(VDF-HFP) based film was stretched 6-time in the direction perpendicular to the extrusion machine direction. The Al layer was evaporated by thermal evaporation. The Si₃N₄ layer was deposited by plasma-enhanced vapor deposition. Additional 40 nm thick Al electrodes were evaporated on both sides of the multilayer structure. The capacitor film had a capacitance of 1.02 nF. It was charged with a constant current of 1 μA with an upper voltage limit of 800 V. On charging, it took 1.25 seconds to arrive 800 V, and the current then dropped to ˜30 nA.

FIG. 15 is a chemical structure of a thermally stable cross-linking agent that may be used in embodiments of the present invention.

### Other High Dielectric Constant Materials

Based on the same theoretical principle, the multilayer approach can also be used to reduce the dielectric loss and energy loss of other high energy density capacitor films.

FIG. 16 shows celluloses with high dielectric constant (above 5). In representative examples, R is CN—, CNCH₂—, CNCH₂CH₂—, CF₃—, CF₃CH₂—, or CF₃CH₂CH₂—, and R′ is —CH₂CH₃ or —H. In embodiments of the present invention, the high energy density layer may be a cellulose polymer, such as a cellulose having a dielectric constant greater than 5.

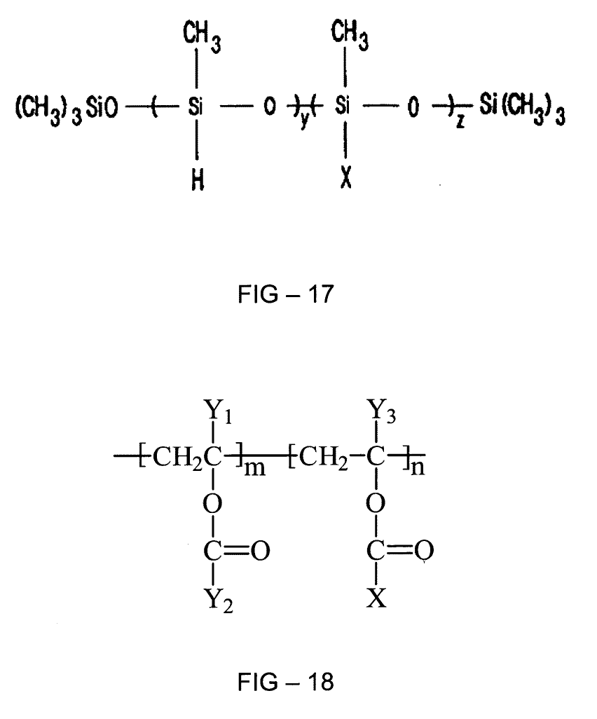

FIG. 17 shows siloxane polymers with high dielectric constant (above 5). X can be selected from CN—, CNCH₂—, CNCH₂CH₂—, CF₃—, CF₃CH₂—, or CF₃CH₂CH₂—, and y/z may vary from 90/10 to 0/100. In embodiments of the present invention, the high energy density layer may be a siloxane polymer, such as a siloxane polymer having a dielectric constant greater than 5.

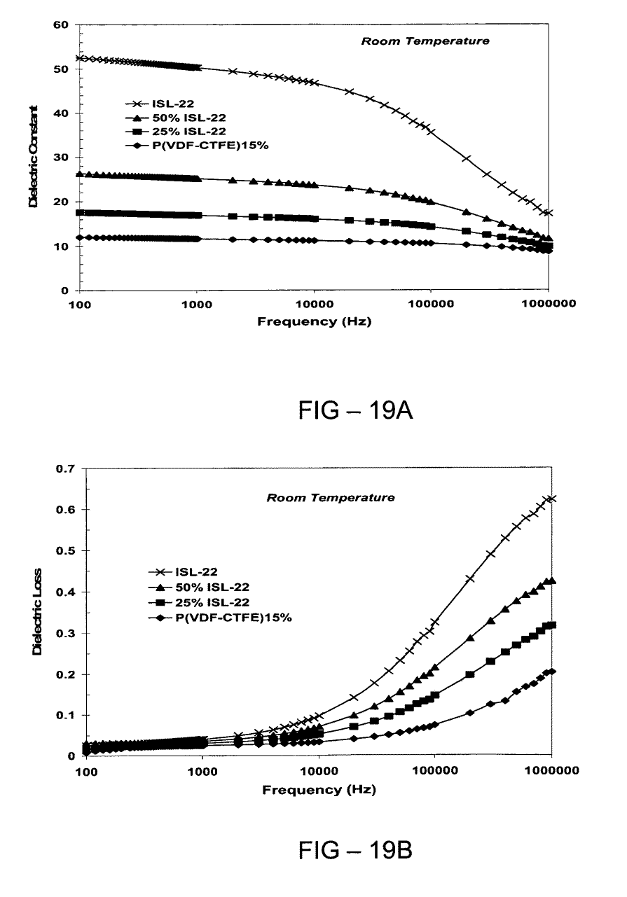

FIG. 18 shows acrylate polymers with high dielectric constant (above 5). X can be selected from CN—, CNCH₂—, CNCH₂CH₂—, CF₃—, CF₃CH₂—, or CF₃CH₂CH₂—. Y₁, Y₂ and Y₃ can be selected from H—, CH₃—, CH₃CH₂—, etc. m/n varies from 90/10 to 0/100. In embodiments of the present invention, the high energy density layer may be an acrylate polymer, such as an acrylate polymer having a dielectric constant greater than 5.

These polar celluloses, siloxanes, and acrylate polymers can have high dielectric constant from 5 to 20, and high energy density above 10 J/cm³. However, they have dielectric loss similar to the PVDF polar fluoropolymers, and they have high leakage current at high electric field. In addition, they are hydrophilic and absorb moisture. Similar to the reduction of dielectric loss and increase in charge-discharge efficiency in the polar fluoropolymers, the use of a blocking layer in a multilayer film can also achieve the same effects in illustrated for other high energy density polymers.

### Blended Polymer Examples

A high energy density dielectric layer may also comprise blends of a PVDF-based polymer with a second polymer, including PVDF copolymers , and including blends of different PVDF-based polymers and/or copolymers. The approaches of this invention can be applied to polymer blends and composites, for example by preparing a blend or composite of a high energy density material and a material suggested for use as a blocking layer in other embodiments.

As a further example, blends of P(VDF-TrFE-CFE) terpolymer and P(VDF-CTFE) copolymer were prepared using the solution method as follows: The two polymers were independently dissolved in dimethylformamide (DMF) at room temperature to make two 5.0 wt % solutions. The two solutions were then mixed together and stirred for more than 2 hours to ensure that two components were mixed well. These solutions with the mixture of two polymers in certain ratio were used for preparing films by a solution casting method, which included applying the solutions to a substrate and drying in an oven at 70° C. for 24 hours. The films were transferred to a vacuum oven at 200° C. for melting and keep the melt state for 30 minutes. They were then cool down to the room temperature. The films may be further annealed at 100-120° C. for several hours under vacuum to improve crystallinity. The blends can also be prepared by an extrusion method.

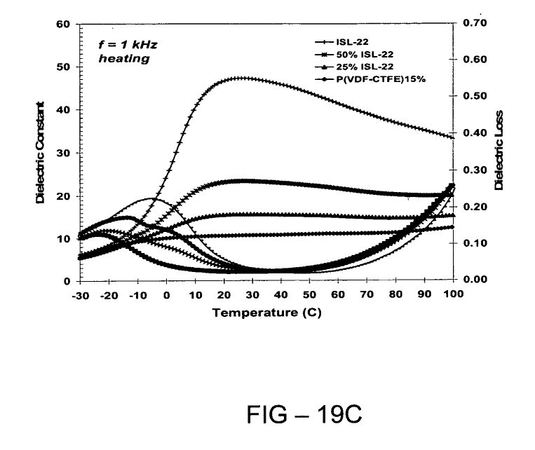

FIGS. 19A-19C shows the dielectric constant and dielectric loss as a function of frequency measured at room temperature (A and B, respectively), and the dielectric constant and loss as a function of temperature measured at 1 kHz (C), for blends with different weight ratio between the terpolymer and copolymer. The figures show the dielectric properties of blends of P(VDF-TrFE-CFE) and P(VDF-CTFE) as a function of frequency measured at room temperature. The dielectric constant and dielectric loss of the blends are in between the two end polymers. By varying the ratio between the two end members, both the dielectric constant and dielectric loss can be tailored between the two end member polymers. By using different end member polymer combinations, different blends can be prepared and tailored to various electrical properties.

To further improve the intermixing of polar-fluoropolymers with dielectric polymers, the polymers may be crosslinked by various crosslinking methods, including using crosslinking agents, and/or an energy source such as UV irradiation, electron-beam, high energy irradiation such as y-ray, etc.

The volume ratio of a polar fluoropolymer to a polymer of lower dielectric loss (e.g. a polymer suggested as a blocking layer component elsewhere in this specification) in a polymer blend can be in the range from 99%:1% to 1%:99% or 95%:5% to 5%:95% or 25%:75% to 75%:25%.

### Multilayer Films

Examples of the present invention include dielectric films, including multilayer dielectric films, a capacitor comprising a dielectric film according to an example of the present invention, such as a film capacitor.

In some examples, the multilayer film may have an AB layer sequence, with one or more high energy density layers (B-layers) having a discharged electric energy density higher than 10 J/cm³ and optionally discharge time faster than 100 millisecond, and one or more blocking layers (A-layers) having an electric resistivity higher than 10¹⁵ Ωcm, more preferably 10¹⁶ Ωcm. For example, the multilayer film may comprise a bilayer film of the form of AB, or other form such as ABA, BAB, ABAB, ABABA, BABAB, ABABAB, and the like. For example, high energy density layers (B-layers) may comprise a polymer having a discharged electric energy density higher than 10 J/cm³ and optionally a discharge time faster than 100 millisecond (for example, as may be determined in a film capacitor formed using the high energy density material), and the blocking layer may comprise a dielectric material having an electric resistivity higher than 10¹⁵ Ωcm, more preferably 10¹⁶ Ωcm or greater.

A multilayer film may comprise A-layers with different compositions. Further, a multilayer film may comprise B-layers with different compositions.

The multilayer film can have different layer constructions, such as A₁B₁A₂B₂A₃B₃A₄B₄ . . . , or A₁A₂B₁B₂A₃B₃ . . . , as long as at least one B layer is used as blocking layer. A₁, A₂, A₃, A₄, etc can be selected from the A-layer materials and B₁, B₂, B₃, B₄, etc can be selected from the B-layer materials.

The volume ratio of high energy density layers (e.g. a polar fluoropolymer) to blocking layers (e.g. a low-loss polymer) can be in the range from 99%:1% to 1%:99% or 95%:5% to 5%:95% or 25%:75% to 75%:25%.

In some example, the thickness ratio between the A-layer and B-layer is in the range of 1/99 to 99/1. In some examples, the layer thickness of A and B layers is in the range from 1 nm to 100 μm. Ranges described herein are inclusive.

The dielectric constant of the multilayer films may be in the range from 5 to 40 as measured at 1 kHz and dielectric loss can be below 2% or preferably below 1% (measured at 1 kHz).

In some examples, one or more of the polymers used to form a polymer film can have an average molecular weight that is greater than about 100,000, or any value that is appropriate for a desired application. Component polymers can also be crosslinked if desired.

In some examples, the discharged electric energy density of a multilayer film is higher than 8 J/cm³, more preferably greater than 10 J/cm³, and/or the discharge time of a capacitor including such a film may be less than 10 ms (0.01 s). The efficiency of the capacitor as defined in the equation (2) can higher than 80%. In representative examples, the dielectric constant of the multilayer film may be greater than about 9, the dielectric loss may be less than about 1%, and operating temperature range may be up to 145° C. or greater. Polymer systems, such as multilayers, according to embodiments of the present invention may be flexible and can be easily processed to thin films, having a high electric energy density, in some examples greater than about 8 J/cm³, and in particular examples greater than about 10 J/cm³.

A multilayer film can include different composition high energy density layers in the same film. A multilayer film can include different composition blocking layers in the same film.

### Operating Temperature

A multilayer film may have a high operating temperature, e.g., greater than about 145° C. Such systems can be formed, for example, by combining one or more polar fluoropolymer with one or more dielectric polymers where one or more of the polymers have a high glass transition temperature and/or melting temperature. For example, the dielectric polymer can possess high glass transition temperatures (e.g., greater than about 120° C.), and/or high melting points (e.g., greater than about 200° C.). Hence, the resulting polymer systems can be used in applications, such as capacitors, that are exposed to high temperatures, such as temperatures above about 145° C.

### Fabrication

A multilayer film can be produced by spin coating, solution casting, melt extrusion, vapor deposition, plasma deposition, other process, or process combining two or more of such deposition methods. For example, the deposition of the high energy density film may use a first deposition process, and deposition of the blocking layer may use a second deposition process. For example, a multilayer film can be prepared by combining the spin coating, extrusion, and/or vapor deposition. Vapor deposition may include a polymerization process.

For example, a multilayer film can be prepared by co-extrusion of a high energy density layer and a blocking layer through a multiple film die.

A multilayer film can be prepared by vapor deposition of different layers, for example vapor deposition of a high energy density layer on a first electrode, vapor deposition of a blocking layer, and deposition of a second electrode.

An improved charge storage device can be fabricated by depositing a high energy density layer on a substrate, followed by deposition of a blocking layer. The substrate may include an electrode, and a second electrode can be deposited after deposition of the blocking layer.

A multilayer film can be fabricated using multilayer co-extrusion method, layer-by-layer spin cast method, layer-by-layer plasma polymerization method, or self-assembled block copolymer method.

For example, a melt extrusion method can include mixing together one or more polar-fluoropolymers with one or more dielectric polymers in a predetermined weight ratio and prior to or during extruding the polymers through an extruder. A polymeric material according to an embodiment of the present invention can thus take on various forms.

A solution casting method can include completely or partially dissolving one or more polar-fluoropolymers and one or more dielectric polymers in one or more solvents to form one or more solutions. The polymers can be dissolved in a predetermined weight ratio and can be dissolved at any appropriate temperature including room temperature or a temperature higher than room temperature. The solution can then poured on a substrate or container and the solvent evaporated. The evaporated solution can then be formed into a film. Polymers used in blocking layers and/or high energy density layers may be crosslinked by various crosslinking methods, including using crosslinking agents, and/or an energy source such as UV irradiation, electron-beam, high energy irradiation such as gamma-ray, and the like.

### High Energy Density Polymers

A high energy density layer may comprise a high energy density material, in particular a high energy density polymer, for example a polymer selected from: polar fluoropolymers such as PVDF, P(VDF-CTFE), P(VDF-CFE), P(VDF-HFP), P(VDF-CDFE), P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), and P(VDF-TFE-CDFE); polar celluloses (FIG. 16 provides example chemical structures, preferably with CN—, CNCH₂—, CNCH₂CH₂—, CF₃—, CF₃CH₂—, or CF₃CH₂CH₂— pendant groups for high dielectric constant); siloxane polymer, in particular polar siloxane polymers (see for example FIG. 17, preferably with CN—, CNCH₂—, CNCH₂CH₂—, CF₃—, CF₃CH₂—, or CF₃CH₂CH₂— pendant groups for high dielectric constant); and acrylate polymers (see for example FIG. 18, preferably with CN—, CNCH₂—, CNCH₂CH₂—, CF₃—, CF₃CH₂—, or CF₃CH₂CH₂— pendant groups for high dielectric constant).

The following abbreviations are used: VDF: vinylidenedifluoroethylene, CTFE: chlorotrifluoroethylene, CFE: chlorofluoroethylene, CDFE: chlorodifluoroethylene, TrFE: trifluoroethylene, TFE: tetrafluoroethylene, HFP: hexafluoropropylene, or any other polymers, blends, or composites which exhibit a dielectric constant higher than 5 and an energy density higher than 10 J/cm³.

In some examples, example high energy density polymers include copolymers, in some cases terpolymers, such as P(VDF-CTFE), P(VDF-CFE), P(VDF-HFP), P(VDF-CDFE), P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), P(VDF-TFE-CDFE). The mol % of CTFE, or CFE, or HFP, or CDFE in the copolymers and terpolymers can be in the range between 0 mol % and 10 mol %. The mol % of TrFE or TFE in the terpolymers is in the range between 0 mol % and 15 mol %.

Example high energy density materials also include polymer blends, such as a polymer blend of a PVDF-based polymer, such as a PVDF-based homopolymer, with a copolymer selected from the group consisting of: P(VDF-CTFE); P(VDF-CFE); P(VDF-HFP); and P(VDF-CDFE) or a polymer blend of a PVDF homopolymer with a terpolymer selected from the group consisting of: P(VDF-TrFE-CTFE); P(VDF-TrFE-CFE); P(VDF-TrFE-HFP); P(VDF-TrFE-CDFE); P(VDF-TFE-CTFE); P(VDF-TFE-CFE); P(VDF-TFE-HFP); and P(VDF-TFE-CDFE), including, for example, polymer blends with either a PVDF homopolymer or a copolymer and a terpolymer. The copolymer is selected from one of the following: P(VDF-CTFE); P(VDF-CFE); P(VDF-HFP); and P(VDF-CDFE).

Other examples include a polymer blend of a copolymer selected from the group consisting of: P(VDF-CTFE); P(VDF-CFE); P(VDF-HFP); and P(VDF-CDFE); with a terpolymer selected from the group consisting of: P(VDF-TrFE-CTFE); P(VDF-TrFE-CFE); P(VDF-TrFE-HFP); P(VDF-TrFE-CDFE); P(VDF-TFE-CTFE); P(VDF-TFE-CFE); P(VDF-TFE-HFP); and P(VDF-TFE-CDFE). The terpolymer is selected from the following: P(VDF-TrFE-CTFE); P(VDF-TrFE-CFE); P(VDF-TrFE-HFP); P(VDF-TrFE-CDFE); P(VDF-TFE-CTFE); P(VDF-TFE-CFE); P(VDF-TFE-HFP); and P(VDF-TFE-CDFE).

Example compositions for the copolymer in a blend of PVDF homopolymer or a copolymer and a terpolymer is at CTFE or CFE or HFP or CDFE in the range of 0 mol % to 10 mol % and the terpolymer is at TrFE or TFE mol % in the range from 20 mol % to 40 mol % and at CTFE, or CFE, or HFP, or CDFE in the range of 3 to 10 mol %.

The copolymer, terpolymer, and blends of PVDF homopolymer or a copolymer and a terpolymer films may be uniaxially stretched to a drawing ratio from 0× to 8× (zero times to 8 times) of the original length.

The copolymer, terpolymer, and blends of PVDF homopolymer or a copolymer and a terpolymer films may biaxially stretched to a stretching ratio from 0× to 5× of the original length in either or both directions.

The stored electric energy density of these example polymer films may be at least about 10 J/cm³ under an electric field higher than 450 MV/m, preferably between about 12 to about 30 J/cm³ under an electric field higher than 450 MV/m, and more preferably between about 12 to about 22 J/cm³ under an electric field higher than 450 MV/m.

The discharge time (release of 90% of the stored energy) of a polymer thin film capacitor (˜0.1 μF) to a 1000 ohm load may be less than 1 ms.

The discharge efficiency, as defined by the ratio of the discharged energy density to the stored energy density (which can be directly derived from FIG. 3 and FIG. 6 using equation 3), may be better than 80% for 1 ms discharge time.

These example polymers may possess a stable non-polar phase after the uniaxial drawing of the film to more than 5× or application of electric field of higher than 400 MV/m at temperatures above 50° C.

### Cross-Linking of High-Energy Density Polymer

When the high energy density layer is a fluoropolymer, the B-layer can be crosslinked via crosslinking agents selected from divinylmultimethylsiloxanes (DVMMS) with initiators such as organic peroxides such as benzoyl peroxide (BPO) and dicumyl peroxide (DCP), azo compounds, for example aliphatic azo compounds such as azobisisobutyronitrile, halogens and other free radical initiators; diacrylmultimethysiloxanes with UV light irradiation or high energy particle irradiation; plasma polymerization or vapor deposition polymerization

The high energy density layer and/or dielectric blocking layer may comprise a crosslinked polymer.

### Blocking Layer

Examples of dielectric polymers that may be used in blocking layers include polydimethylphenyleneoxide, polystyrene (PS), polyimides (PI), polysulfone and polypropylene (PP).

Examples also include inorganic dielectrics, including nitrides, oxides, carbides, and the like.The blocking layer may be selected from Si₃N₄, AlN, HfO₂, PC, PPO, PS, diamond-like-carbon, or any materials, blends, or composites which possesses a dielectric dissipation factor less than 5%, and preferably less than 1%, and a volume electric resistivity higher than 10¹⁵ Ω·cm, and preferably higher than 10¹⁶ Ω·cm.

Preferably, the dielectric constant of the blocking layer material is greater than about 3, and is preferably greater than about 5 (measured at 1 kHz).

In some examples, for the multilayer films, both A-layers and B-layers can be chosen from the polar fluoropolymers, in which the blocking layers (A-layers) are selected from P(VDF-TFE-CTFE), P(VDF-TrFECFE), P(VDF-TrFE-HFP) or similar fluoropolymer terpolymers which possess room temperature dielectric constant around 50. For example, the layer B may then be selected from PVDF, P(VDF-HFP), P(VDF-CFE), P(VDF-CTFE), P(VDF-TrFE), P(VDF-TFE) and other similar copolymers. In some examples, the blocking layer may be an acrylate polymer.

High temperature stability is very important for certain applications such as hybrid electric vehicles and converters/inverters based on SiC. For such applications, in some examples, an inorganic blocking layer may be used, such as a nitride, oxide, carbide, and the like.

### Conducting Layer

A thin conductive layer may be located between a high energy density layer and a dielectric blocking layer to improve the reliability of a multilayer film. The thin conductive layer may have different electric patterns. A thin conductive layer may comprise a metal, such as Al, Ag, Au, Pt, or a conductive polymers. The thickness of the conductive layer can be in the range from 1 nm to 100 nm.

### Applications

Applications include charge storage devices, such as capacitors. Applications include defibrillators, electric vehicles, and field effect transistors. Materials described herein, such as multilayer films, can also be used for actuators with improved elastic modulus and reliability, actuator arrays, sensors, sensor arrays, and the like.

### Further Discussion and Representative Examples

Examples of the present invention include approaches to reduce the dielectric loss of PVDF-based polar fluoropolymers by providing a multilayer film comprising at least one layer of PVDF-based polymer and at least one blocking layer, e.g. a layer of dielectric material (organic or inorganic) with low dielectric loss and high volume resistivity, for example as compared to the PVDF-based polymer. For example, the dielectric loss of the blocking layer may be at least 50% less thant the high energy density material used at a given frequency, e.g. 1 kHz or other operating frequency. The polymer multilayer structure can be bilayer, trilayer, or other multilayer.

Multilayer structures can be prepared by spin coating, vapor deposition, coextrustion, and other methods. PVDF-based polymers have compositions such as PVDF, PVDF-CTFE, PVDF-HFP, PVDF-TrFE-CFE, etc), and multilayer structures may include high energy density mixtures (blends) including one or more polar fluoropolymers. The blocking layer (e.g. a dielectric layer with low dielectric loss) may be PS, PPO, Si₃N₄, for example. Silicon nitride has a high dielectric constant (K) and gives good performance in multilayer structures, and PS and PPO also have good performance. The approach can be extended to other high energy density high dielectric polymers, particularly to materials that have high dielectric loss, similar to PVDF.

Hence, examples of the present invention include a capacitor comprising a polymer film, for example a polymer multilayer film. In some examples, a multilayer film may comprise a non-polymeric blocking layer (such as an inorganic dielectric). In some examples, the high energy density layer may be a ferroelectric material, such as a polymer ferroelectric or in some examples an inorganic ferroelectric. A polymer dielectric film may comprise a polymer multilayer or polymer blend, with one polymer selected from PVDF, P(VDF-CTFE), P(VDF-CFE), P(VDF-HFP), P(VDF-CDFE), P(VDF-TrFE-CTFE), P(VDF-TrFECFE), P(VDF-TrFE-HFP), P(VDF-TrFE-CDFE), P(VDF-TFE-CTFE), P(VDFTFE-CFE), P(VDF-TFE-HFP), P(VDF-TFE-CDFE), and another polymer selected from PPO, PS, PDMS, PP, PE, PPS, polyimide, Kapton, other polymer given in Table 1 or other low-loss polymer (for example, having a dielectric loss less than 1% at 1 kHz or other relevant frequency.

The volume ratio between the two polymers (or high energy density polymer and other blocking layer material) may be in the range from 1/99 vol % to 99/1 vol %. Polymers, including polymer blends, can be crosslinked via crosslinking agents, for example divinylmultimethylsiloxanes (DVMMS) with initiators such as benzyoyl peroxide (BPO), AIBN, DCP, or other initiator that can generate free radicals; diacrylmultimethysiloxanes with UV light irradiation or high energy particle irradiation; plasma polymerization or vapor deposition polymerization. The dielectric constant of the multilayers or blends can be in the range from 3 to 100, more preferably from 3 to 50, as measured at 1 kHz and dielectric loss can be below 5%, and is preferably below 1%. The electric energy density of the multilayer or blend film can be higher than 8 J/cm³. The discharge time of a capacitor including a multilayer film can be less than 1 ms (0.001 s).

The polymer dielectric film may be a multilayer film comprising or consisting of an ABABAB . . . layer sequence (including AB bilayers, ABA, BAB trilayers, and the like), where high energy density layers (B-layers) can be selected from PVDF, P(VDF-CTFE), P(VDF-CFE), P(VDFHFP), P(VDF-CDFE), P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDFTFE-HFP), P(VDF-TFE-CDFE) and A-layers can be selected from PPO, PS, PDMS, PP, PE, PPS, Kapton, or parylene. In some examples, the B-layers can be selected from PVDF, P(VDF-CTFE), P(VDF-CFE), P(VDF-HFP), P(VDF-CDFE), and the B-layers from P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), P(VDF-TFE-CDFE), the terpolymers being used in these examples as a blocking layer.

The thickness ratio of A-layers (blocking layers) to B-layers (high energy density layers) can be in the range of 1/99 to 99/1. In some example, the thickness ratio between a single A-layer (blocking layer) and a single B-layer (high energy density layer) is in the range of 5/95 to 95/5, such as 10/90 to 90/10, and preferably in the range 5/95 to 60/40. In some examples, the thickness ratio between a single A-layer and a single B-layer is in the range of 20/80 to 60/40. In some example, the thickness ratio between a single A-layer and a single B-layer is in the range of 30/70 to 60/40, and in some examples may be approximately the same thickness (50/50).

An example process to reduce dielectric loss in a capacitor includes providing a multilayer film dielectric including a high energy density layer and a blocking layer, the blocking layer having substantially lower dielectric loss than the high energy layer, for example at least 50% lower.

An example process to reduce conductivity loss in a capacitor includes providing a multilayer film dielectric including a high energy density layer and a blocking layer, the blocking layer having substantially higher electrical resisitivity than the high energy density layer, for example at least an order of magnitude greater, and in some examples at least two orders of magnitude greater. In examples, comparisons may be made at the breakdown field, or at 50 MV/m or greater electric fields.

The layer thickness of each layer of a multilayer film can be in the range from 1 nm to 1000 nm. The dielectric constant of the multilayer film may be in the range from 5-40 and dielectric loss may be below 5% and is preferably below 1%. The electric energy density of the multilayer film may be higher than 8 J/cm³, and may be lower than that of the high energy density material used in the high energy density layer. However, the reduction in losses may offset any reduction in energy density (when compared at a similar field), and may allow higher fields to be used. The discharge time of the multilayer film may be less than 1 ms (0.001 s). These materials, such as multilayer films, can also be used for actuators with improved elastic modulus and reliability, and also as sensors, including sensor arrays.

It should be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention.

Patents or publications mentioned in this specification are herein incorporated by reference to the same extent as if each individual publication was specifically and individually indicated to be incorporated by reference.

Examples given are intended to illustrate embodiments of the invention and are not limiting in nature. Those skilled in the art will recognize, or be able to ascertain, using no more than routine experimentation, numerous equivalents to the specific substances and procedures described herein.

The invention is not restricted to the illustrative examples described above. Examples described are exemplary, and are not intended to limit the scope of the invention. Changes therein, other combinations of elements, and other uses will occur to those skilled in the art. The scope of the invention is defined by the scope of the claims.

Having described our invention, we claim:

1. An apparatus, comprising:
a first electrode;
a second electrode; and
a multilayer film located between the first electrode and the second electrode, the multilayer film comprising:
a high energy density layer, the high energy density layer comprising a high energy density material providing an electric energy density higher than 10 J/cm³; and
a blocking layer, the blocking layer being a dielectric layer having an electric resistivity approximately equal to or greater than 10¹⁵ Ω·cm.

2. The apparatus of claim 1, the apparatus being a charge storage device.

3. The apparatus of claim 1, wherein the high energy density material is a polar polymer.

4. The apparatus of claim 1, wherein the high energy density material is a fluoropolymer.

5. The apparatus of claim 1, wherein the high energy density material is a polar fluoropolymer.

6. The apparatus of claim 5 wherein the polar fluoropolymer is a polymer or copolymer of poly-1,1-difluoroethene.

7. The apparatus of claim 5 wherein the polar fluoropolymer is a polymer or copolymer of a poly-1,1-difluoroethene derivative.

8. The apparatus of claim 1, wherein the high energy density layer comprises a fluoropolymer, or blend thereof, the fluoropolymer being selected from a group of fluoropolymers comprising: PVDF, P(VDF-CTFE), P(VDF-CDFE), P(VDF-CFE), P(VDF-HFP), P(VDF-CDFE), P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), and P(VDF-TFE-CDFE),
wherein VDF: vinylidenedifluoroethylene, HFP: hexafluoropropylene, VDF: vinylidenedifluoroethylene, CTFE: chlorotrifluoroethylene, CFE: chlorofluoroethylene, CDFE: chlorodifluoroethylene, TrFE: trifluoroethylene, and TFE: tetrafluoroethylene.

9. The apparatus of claim 1, wherein the blocking layer comprises an inorganic dielectric layer.

10. The apparatus of claim 9, wherein the inorganic dielectric layer comprises an inorganic nitride, inorganic oxide, or diamond-like carbon.

11. The apparatus of claim 1, wherein the blocking layer comprises a non-polar polymer layer.

12. The apparatus of claim 1, wherein the blocking layer comprises a polymer selected from a group of polymers comprising: polystyrene, polycarbonates, polypropylene, poly(2,6-dimethy-1,4-phenylene oxide), polyethylene terephthalate, polyethylene naphthalate, poly(ethylene-co-tetrafluoroethylene), polyetheretherketone, poly(phenylene sulfide), polyether imide, poly(diaminodiphenylmethane/4,4′-diphenylmethane diisocyanate), and polysulfone.

13. The apparatus of claim 1, wherein the blocking layer has a dielectric loss less than 1%.

14. The apparatus of claim 1, wherein the multilayer film further comprises an electrically conducting film disposed between the high energy density layer and the dielectric layer.

15. The apparatus of claim 1, wherein the high energy density layer has a dielectric constant greater than 5.

16. The apparatus of claim 15, wherein the high energy density layer comprises a cellulose polymer.

17. The apparatus of claim 15, wherein the high energy density layer comprises a siloxane polymer.

18. The apparatus of claim 15, wherein the high energy density layer comprises an acrylate polymer.

19. The apparatus of claim 1, the multilayer film being a bilayer film.

20. The apparatus of claim 1, the multilayer film having a plurality of high energy density layers and at least one blocking layer.

21. The apparatus of claim 1, the multilayer film having a layer thickness ratio defined as a thickness of the blocking layer divided by a thickness of the high energy density layer,
the layer thickness ratio being in the range 1/99 to 99/1.

22. The apparatus of claim 21, the layer thickness ratio being in the range 5/95 to 95/5.

23. The apparatus of claim 21, the layer thickness ratio being in the range 5/95 to 60/40.

24. The apparatus of claim 1, wherein the multilayer film has an overall dielectric constant higher than 5 at 1 kHz, and a dielectric loss lower than about 3%.

25. The apparatus of claim 1, wherein the high energy density layer has a thickness between 10 nm and 5 microns.

26. The apparatus of claim 1, the multilayer film comprising a plurality of high energy density layers and a plurality of blocking layers arranged in an alternating sequence.

27. An apparatus, comprising:
a first electrode;
a second electrode; and
a multilayer film located between the first electrode and the second electrode, the multilayer film comprising:
a high energy density layer; and
a blocking layer, the blocking layer being a dielectric layer having an electric resistivity approximately equal to or greater than 10¹⁶ Ω·cm,
wherein the high energy density layer comprises a polar fluoropolymer.

28. The apparatus of claim 27, wherein the blocking layer is an inorganic dielectric layer.

29. The apparatus of claim 27, wherein the blocking layer is an non-polar dielectric polymer layer.

30. The apparatus of claim 27, further comprising a conducting layer between the high energy density layer and the blocking layer.

31. The apparatus of claim 27, comprising a plurality of high energy density layers and a plurality of blocking layers, the high energy density layers alternating with the blocking layers.

32. A process to fabricate a charge storage apparatus, comprising:
preparing a multilayer film, the multilayer film comprising at least one high energy density layer and at least one blocking layer; and
locating the multilayer film between a pair of electrodes.

33. The process of claim 32, wherein the high energy density layer comprises a polar fluoropolymer.

34. The process of claim 32, wherein the multilayer film is prepared using spin coating.

35. The process of claim 32 wherein the multilayer film is prepared using a coextrusion of the high energy density layer and the dielectric layer through a multiple film die.

36. The process of claim 32, wherein the multilayer film is prepared using vapor deposition.
